(19) United States
(12) Patent Application Publication
(10) Pub. No.: US 2026/0054721 A1
(43) Pub. Date: Feb. 26, 2026

(54) METHOD AND APPARATUS FOR PROVIDING FORWARD COLLISION-AVOIDANCE ASSISTANCE FOR VEHICLE

(71) Applicants: Hyundai Motor Company, Seoul (KR); Kia Corporation, Seoul (KR)

(72) Inventors: Yon Jun Jang, Hwaseong (KR); Na Hyun Kweon, Hwaseong (KR); Jae Woong Choi, Hwaseong (KR); Hyun Su Kim, Hwaseong (KR)

(21) Appl. No.: 19/242,610

(22) Filed: Jun. 18, 2025

(30) Foreign Application Priority Data
Aug. 22, 2024 (KR) 10-2024-0112668

(51) Int. Cl. B60W 30/095; B60W 60/00

(52) U.S. Cl. CPC B60W 30/0956; B60W 60/0015; B60W 2520/105; B60W 2554/404

(57) ABSTRACT

A method and an apparatus can provide forward collision-avoidance assistance. The method for preventing a collision between a vehicle and a target in front of the vehicle includes: obtaining vehicle acceleration and relative target acceleration, using at least one sensor of the vehicle, where the vehicle acceleration is an absolute acceleration of the vehicle and the relative target acceleration is a relative acceleration of the target relative to the vehicle; determining target acceleration based on the vehicle acceleration and the relative target acceleration, where the target acceleration is an absolute acceleration of the target; and determining time-to-collision (TTC) based on the target acceleration.

### CROSS-REFERENCE TO RELATED APPLICATION

This application claims under 35 U.S.C. § 119(a) the benefit of Korean Patent Application No. 10-2024-0112668, filed on Aug. 22, 2024 in the Korea Intellectual Property Office, the entire contents of which are incorporated herein by reference.

### BACKGROUND

### (a) Technical Field

The present disclosure relates to a method and an apparatus for providing forward collision-avoidance assistance for a vehicle, more particularly, to the method and apparatus for preventing collision between the vehicle and a target located in front by determining a time-to-collision by taking into account an acceleration measurement error due to acceleration or deceleration of the vehicle.

### (b) Description of the Related Art

Forward collision-avoidance assist (FCA) is a technology related to autonomous driving of a vehicle, which is a driving safety function that helps prevent an autonomous driving vehicle from colliding with a target located in front during autonomous driving. For example, a FCA device determines the risk of collision with another vehicle driving in front of the vehicle and if the possibility of collision is high, warns the driver of the risk of collision or automatically controls driving to prevent forward collision.

To determine the risk of collision, a FCA device calculates the time-to-collision (TTC) between the autonomous driving vehicle and a forward target, and compares the TTC with a predetermined reference time. If the TTC is less than the predetermined reference time, the FCA device determines that there is a high risk of collision and activates an emergency braking system.

The TTC may be calculated by generating a candidate position group of vehicle and a candidate position group of target and by calculating the time point at which the vehicle position and the target position overlap. The candidate position group of target is generated using target movement information such as the target position, velocity, and acceleration acquired using sensors included in the vehicle. Therefore, to calculate a reliable TTC, an accurate candidate position group of target has to be generated, and to this end, the error in the target movement information acquired from the sensors has to be small.

However, when an autonomous driving vehicle decelerates rapidly, a phase difference occurs in the sensor output due to the time difference between the time the sensor recognizes the target and the time the sensor outputs a measured value, and an error is introduced into the acceleration value of the target.

Since there is a high possibility that the collision risk decision will be inaccurate if the target's acceleration value contains an error due to the deceleration of the autonomous driving vehicle, conventional FCA devices employed a constant velocity (CV) model that ignores the target's acceleration. However, the use of the constant velocity model leads to a problem that the autonomous driving vehicle fails to perform the collision risk decision correctly in a situation when the target is decelerating.

### SUMMARY

An object of the present disclosure is to provide a method and an apparatus capable of generating a candidate position group of targets by considering a target's acceleration even when the target vehicle is decelerating.

An object of the present disclosure is to provide a method and an apparatus capable of accurately determining the risk of collision even when the autonomous driving vehicle applies emergency braking as the target in front decelerates.

Technical objects to be achieved by the present disclosure are not limited to those described above, and other technical objects not mentioned above may also be clearly understood from the detailed descriptions given below by those skilled in the art to which the present disclosure belongs.

An embodiment of the present disclosure provides a method for preventing a collision between a vehicle and a target in front of the vehicle including steps of: obtaining, by at least one processor, vehicle acceleration and relative target acceleration, using at least one sensor of the vehicle, wherein the vehicle acceleration is an absolute acceleration of the vehicle and the relative target acceleration is a relative acceleration of the target relative to the vehicle; determining, by the at least one processor, a target acceleration based on the vehicle acceleration and the relative target acceleration, wherein the target acceleration is an absolute acceleration of the target; and determining, by the at least one processor, a time-to-collision (TTC) based on the target acceleration.

According to another aspect, a method for preventing a collision between a vehicle and a target in front of the vehicle includes steps of: obtaining vehicle acceleration and relative target acceleration, using at least one sensor of the vehicle, wherein the vehicle acceleration is absolute acceleration of the vehicle and the relative target acceleration is relative acceleration of the target relative to the vehicle; determining target acceleration based on the vehicle acceleration and the relative target acceleration, wherein the target acceleration is absolute acceleration of the target; and determining time-to-collision (TTC) based on the target acceleration.

Another embodiment of the present disclosure provides an apparatus for preventing a collision between a vehicle and a target in front of the vehicle, the apparatus comprising: at least one memory storing commands; and at least one processor, wherein the at least one processor executes the commands to: obtain vehicle acceleration and relative target acceleration, using at least one sensor of the vehicle, wherein the vehicle acceleration is absolute acceleration of the vehicle and the relative target acceleration is relative acceleration of the target relative to the vehicle; determine target acceleration based on the vehicle acceleration and the relative target acceleration, wherein the target acceleration is absolute acceleration of the target; and determine time-to-collision (TTC) based on the target acceleration.

According to an embodiment of the present disclosure, the TTC may be calculated more accurately by generating a candidate position group of target by considering a target's acceleration even when the target vehicle is decelerating.

According to an embodiment of the present disclosure, activation of an emergency braking system may be triggered earlier in a collision risk situation by generating a candidate position group of targets by considering a target's acceleration even when the target vehicle is decelerating.

According to an embodiment of the present disclosure, the FCA function may operate correctly even when a target in front decelerates and the autonomous driving vehicle applies emergency braking.

According to a further aspect, a non-transitory computer readable medium containing program instructions executed by a processor includes: program instructions that obtain vehicle acceleration and relative target acceleration, using at least one sensor of a vehicle, wherein the vehicle acceleration is an absolute acceleration of the vehicle and the relative target acceleration is a relative acceleration of the target relative to the vehicle; program instructions that determine a target acceleration based on the vehicle acceleration and the relative target acceleration, wherein the target acceleration is an absolute acceleration of the target; and program instructions that determine a time-to-collision (TTC) based on the target acceleration.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 shows a block diagram of a FCA device according to one embodiment of the present disclosure.

FIGS. 2A to 2C illustrate a situation where a FCA device according to one embodiment of the present disclosure generates a candidate position group of vehicle and a candidate position group of target and calculates a TTC.

FIGS. 3A to 3C are graphs illustrating the error in the acceleration value of a target generated due to abrupt deceleration of an autonomous driving vehicle.

FIG. 4 is a flow diagram illustrating a process of determining a target's acceleration to generate a candidate position group of target by a FCA device according to one embodiment of the present disclosure.

FIGS. 5A and 5B are drawings comparing the collision risk decision of a conventional FCA device with that of a FCA device according to the present disclosure when a vehicle applies emergency braking in the CCRb scenario.

FIG. 6 is a graph illustrating the time point at which emergency braking is applied when a FCA device according to the present disclosure is used and the time point at which emergency braking is applied when a conventional FCA device is used.

FIG. 7 is a block diagram of an exemplary computing device that may be used for implementing the method or the device according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

In the present disclosure, forward collision-avoidance assist (FCA) is a function that determines the risk of collision between an autonomous driving vehicle driving on a road and a forward target and if the possibility of collision is high, warns the driver of the risk of collision with the forward target and automatically controls driving of the vehicle to prevent forward collision.

In the present disclosure, collision risk decision refers to determining the possibility of collision between the subject vehicle and the target. Forward collision-avoidance assist (FCA) compares the TTC with a predetermined reference time; if the TTC is less than or equal to the predetermined reference time, FCA determines that collision risk is high; if the TTC is greater than or equal to the predetermined reference time, FCA determines that the collision risk is low.

In the present disclosure, time-to-collision (TTC) refers to the time at which collision occurs between the subject vehicle and the target. The FCA device acquires the time points at which the vehicle and the target overlap with each other by using a candidate position group of vehicles and a candidate position group of targets and determines the earliest of the overlapping time points as the TTC.

In the present disclosure, a candidate position group of vehicle refers to candidate vehicle positions generated by predicting the vehicle position at each time point from the current time point to a specific time in the future. The candidate position group of vehicle may be generated using the current position, velocity, and acceleration of the vehicle. In the present disclosure, a candidate position group of target refers to candidate target positions generated by predicting the target position at each time point from the current time point to a specific time in the future. The candidate position group of target may be generated using the current position, speed, and acceleration of the target.

In the present disclosure, acceleration refers to absolute acceleration unless otherwise specified. In the present disclosure, relative acceleration refers to the acceleration of a target with respect to the subject vehicle. In one embodiment of the present disclosure, acceleration refers to, but not limited to, the acceleration in the longitudinal direction, i.e., acceleration in the driving direction. In another embodiment of the present disclosure, acceleration may be used as a concept including both the longitudinal acceleration and lateral acceleration.

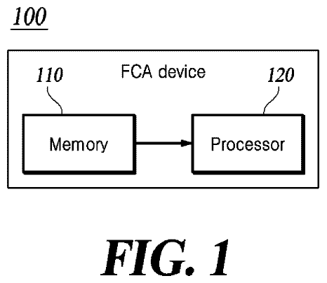

FIG. 1 shows a block diagram of a FCA device according to one embodiment of the present disclosure.

The FCA device 100 includes a memory 110 and a processor 120. The FCA device 100 may be implemented in the form of an embedded device, a server, an electronic device within an autonomous navigation system, and the like. Not all blocks shown in FIG. 1 are essential components, and a portion of blocks included in the FCA device 100 may be added, modified, or deleted in other embodiments. Meanwhile, the constituting elements shown in FIG. 1 represent functionally distinct elements, and at least one constituting element may be implemented in a form in which it is integrated with another element in the actual physical environment.

The memory 110 stores data and commands required for the operation of the FCA device 100. The memory 110 may store drive information of the vehicle acquired using at least one sensor included in the vehicle (in what follows, ‘vehicle’ or ‘subject vehicle’). The drive information of the vehicle may include the velocity, acceleration, steering angle, steering angular velocity, heading angle, and/or yaw rate of the autonomous driving vehicle. The memory 110 may store drive information of the target acquired using at least one sensor included in the vehicle. The drive information of the target may include the target's position, velocity, acceleration, and/or relative acceleration of the target with respect to the vehicle.

The processor 120 controls the overall operation of the FCA device 100. The processor 120 may be implemented with one or more processors. The processor 120 may execute commands stored in the memory 110.

The processor 120 determines the risk of collision with a target, namely, a vehicle, driving in front of the autonomous driving vehicle; if it is determined that there is a high risk of collision, the processor 120 controls the autonomous driving vehicle using an emergency braking system.

The processor 120 determines the TTC between the subject vehicle and the target for collision risk decision and determines whether the TTC is less than or equal to a predetermined reference time. If the TTC is less than or equal to a predetermined reference time, the processor 120 determines that there is a risk of collision and activates the emergency braking system.

To determine the TTC, the processor 120 generates a candidate position group of vehicle using the vehicle's drive information and generates a candidate position group of target using the target's drive information. The processor 120 obtains the time points at which the vehicle and target overlap using the candidate position group of vehicle and the candidate position group of target and determines the earliest point of time among the overlapping time points to be the TTC.

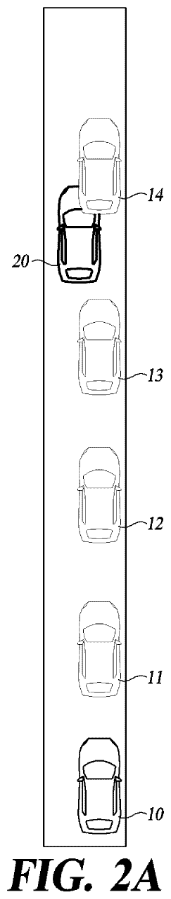

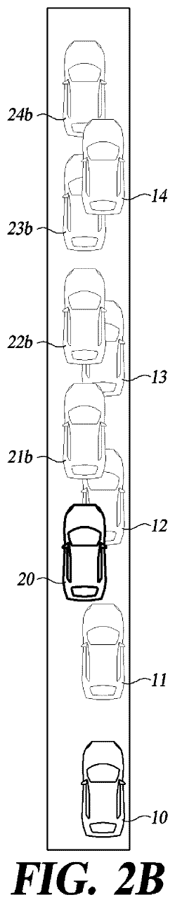

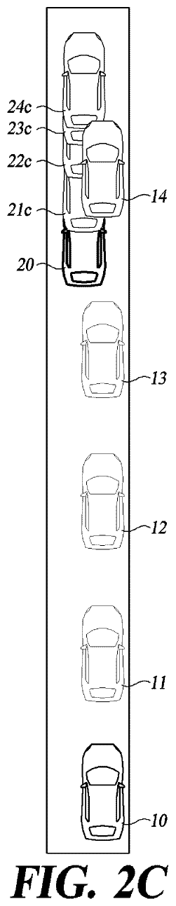

FIGS. 2A to 2C illustrate a situation where the FCA device 100 according to one embodiment of the present disclosure generates a candidate position group of vehicle and a candidate position group of target and calculates a TTC. In FIGS. 2A to 2C, the target 20 is located in front of the vehicle 10, and the vehicle 10 is traveling at a uniform velocity. Since the vehicle is traveling at a uniform velocity, vehicle position candidates (11 to 14) included in the candidate position group of vehicle are spaced at regular intervals.

Situations in which the FCA device 100 has to operate the emergency braking system may be classified into three scenarios (CCRs, CCRm, and CCRb) depending on the drive state of the front vehicle. The Car to Car Rear Stop (CCRs) scenario represents a situation in which the target located in front is stationary. The Car to Car Rear Moving (CCRm) scenario represents a situation in which the target located in front is traveling at a constant speed. The Car to Car Rear Braking (CCRb) scenario represents a situation in which the target located in front is decelerating.

FIG. 2A illustrates a situation in which the FCA device 100 generates the candidate position group of vehicles and the candidate position group of target and calculates the TTC based on the CCRs scenario. Since the acceleration of the target 20 is 0 m/s² in the CCRs scenario, the target position candidates included in the candidate position group of target remain at the same position as the current position of the target 20. The FCA device 100 determines the TTC using the vehicle position candidate 14 overlapping with the target 20.

FIG. 2B illustrates a situation in which the FCA device 100 generates the candidate position group of vehicle and the candidate position group of target and calculates the TTC based on the CCRm scenario. Since the acceleration of the target 20 is 0 m/s² in the CCRm scenario, the target position candidates 21b to 24b included in the candidate position group of target are spaced at regular intervals. The FCA device 100 determines the TTC using the vehicle position candidate 14 and the target position candidate 24b overlapping with each other at the same time point.

FIG. 2C illustrates a situation in which the FCA device 100 generates the candidate position group of vehicle and the candidate position group of target and calculates the TTC based on the CCRb scenario. Since the acceleration of the target 20 has a negative value in the CCRb scenario, the target position candidates 21c to 24c included in the candidate position group of target are spaced at increasingly narrower intervals as the target position candidates are located farther from the current target 20. The FCA device 100 determines the TTC using the vehicle position candidate 14 and the target position candidate 24c overlapping with each other at the same time point.

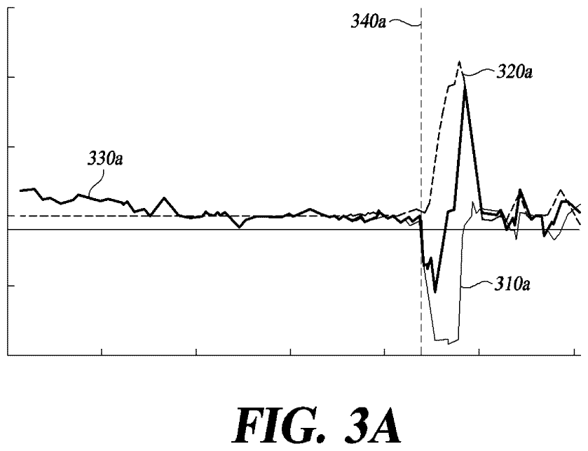

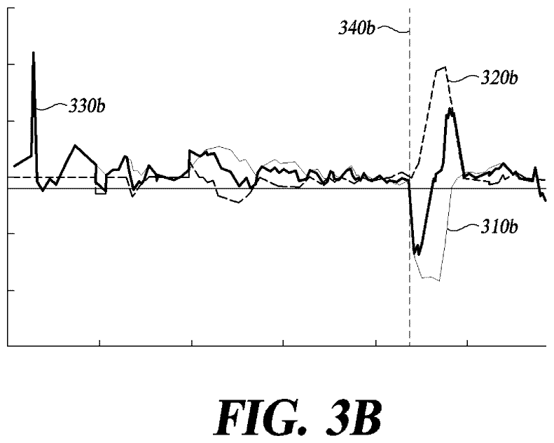

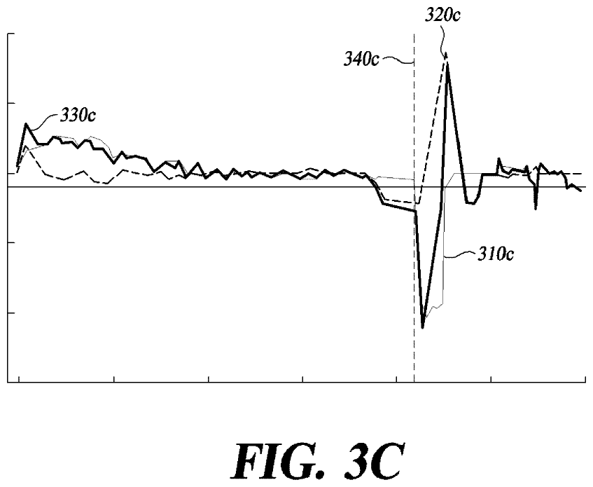

When the vehicle 10 is traveling at a constant speed or is mildly accelerating or decelerating as shown in FIGS. 2A to 3C, the acceleration value of the target 20 obtained from the sensor has no error or only a small error; in this case, the FCA device 100 may accurately calculate the TTC.

However, when the vehicle 10 is abruptly decelerating, a phase difference occurs in the output of the sensor due to the time difference between the time when the sensor recognizes the target 20 and the time when the sensor outputs the measured value, and a large error is introduced into the acceleration value of the target 20.

FIGS. 3A to 3C are graphs illustrating the error in the acceleration value of a target generated due to abrupt deceleration of an autonomous driving vehicle.

FIG. 3A is a graph illustrating the error in the acceleration value of a target generated due to abrupt deceleration of a vehicle in the CCRs scenario. In FIG. 3A, the thin solid line 310a represents the acceleration of the vehicle measured by the sensor, the broken line 320a represents the relative acceleration of the target measured by the sensor, and the thick solid line 330a represents the acceleration of the target calculated using the acceleration of the vehicle and the relative acceleration of the target. The vertical line 340a represents the time point at which an error starts to develop in the sensor output due to the abrupt deceleration of the vehicle, where, in FIG. 3A, the abrupt deceleration 340a corresponds to the time point at which the vehicle's acceleration becomes −1 m/s². Before the abrupt deceleration 340a is applied, the vehicle's acceleration is larger than −1 m/s², and the vehicle's acceleration is less than −1 m/s² after the abrupt deceleration 340a is applied.

In the CCRs scenario, since the target is stationary, the target's acceleration is 0 m/s². Referring to FIG. 3A, the target's acceleration 330a is close to 0 m/s² before the abrupt deceleration point 340a. Since this property conforms to the CCRs scenario, the target's acceleration value may be trusted. However, after the abrupt deceleration point 340a, the magnitude of the target's acceleration 330a increases. Since this property does not conform to the CCRs scenario, the target's acceleration value may not be trusted after the abrupt deceleration point 340a.

FIG. 3B is a graph showing the error in the target's acceleration value generated due to the abrupt deceleration of the vehicle in the CCRm scenario. In FIG. 3B, the thin solid line 310b represents the acceleration of the vehicle measured by the sensor, the broken line 320b represents the relative acceleration of the target measured by the sensor, and the thick solid line 330b represents the acceleration of the target calculated using the acceleration of the vehicle and the relative acceleration of the target. The vertical line 340b represents the time point at which an error starts to develop in the sensor output due to the abrupt deceleration of the vehicle, where, in FIG. 3B, the abrupt deceleration 340b corresponds to the time point at which the vehicle's acceleration becomes −1 m/s². Before the abrupt deceleration 340b is applied, the vehicle's acceleration is larger than −1 m/s², and the vehicle's acceleration is less than −1 m/s² after the abrupt deceleration 340b is applied.

In the CCRm scenario, since the target is traveling at a constant velocity, the acceleration of the target is 0 m/s². Referring to FIG. 3B, before the abrupt deceleration point 340b, the target's acceleration 330b is close to 0 m/s². Since this property conforms to the CCRm scenario, the target's acceleration value may be trusted. However, after the abrupt deceleration point 340b, the target's acceleration 330b increases in magnitude. Since this property does not conform to the CCRm scenario, the target's acceleration value may not be trusted after the abrupt deceleration point 340b.

FIG. 3C is a graph showing the error in the target's acceleration value generated due to the abrupt deceleration of the vehicle in the CCRb scenario. In FIG. 3C, the thin solid line 310c represents the acceleration of the vehicle measured by the sensor, the broken line 320c represents the relative acceleration of the target measured by the sensor, and the thick solid line 330c represents the acceleration of the target calculated using the acceleration of the vehicle and the relative acceleration of the target. The vertical line 340c represents the time point at which an error starts to develop in the sensor output due to the abrupt deceleration of the vehicle, where, in FIG. 3C, the abrupt deceleration 340c corresponds to the time point at which the vehicle's acceleration becomes −1 m/s². Before the abrupt deceleration 340c is applied, the vehicle's acceleration is larger than −1 m/s², and the vehicle's acceleration is less than −1 m/s² after the abrupt deceleration 340c is applied.

In the CCRb scenario, since the target is traveling at a decreasing velocity, the acceleration of the target is less than 0 m/s². Referring to FIG. 3C, before the abrupt deceleration point 340c, the target's acceleration 330c is less than 0 m/s². Since this property conforms to the CCRb scenario, the target's acceleration value may be trusted. However, after the abrupt deceleration point 340c, the magnitude of the target's acceleration 330c increases rapidly. Since this property does not match the pattern of actual acceleration, the target's acceleration value may not be trusted after the abrupt deceleration point 340c.

If a large error is introduced to the acceleration value of the target, the FCA device 100 may not accurately generate a candidate position group of target. if a large error occurs in the acceleration value of the target due to abrupt deceleration of the vehicle, conventional methods applied the constant velocity model that does not consider the acceleration of the target to generate the candidate position group of target. However, to generate an accurate candidate position group of target even when the vehicle rapidly decelerates, the target's acceleration has to be taken into account.

Referring to FIGS. 3A to 3C, a large error occurs in the acceleration value of the target from the time point when the acceleration of the vehicle becomes −1 m/s². Therefore, the acceleration value of the target obtained in a section where the acceleration of the vehicle is less than −1 m/s² may not be trusted. The FCA device 100 according to one embodiment of the present disclosure uses the acceleration of the target at the time point when the acceleration of the vehicle becomes −1 m/s² as the acceleration of the target in the section where the acceleration of the vehicle is less than −1 m/s². In other words, the FCA device 100 determines the acceleration of the target in the abrupt deceleration section by using the relative acceleration of the target measured at the time point when the acceleration of the vehicle becomes −1 m/s².

Meanwhile, since the acceleration of the target 20 is 0 m/s² in the CCRs and CCRm scenarios, there is no need to consider the acceleration of the target 20 when generating the candidate position group of target. On the other hand, since the acceleration of the target is a value other than 0 m/s² in the CCRb scenario, the acceleration of the target has to be considered when generating the candidate position group of target. The FCA device 100 may distinguish the CCRb scenario from the CCRs scenario and the CCRm scenario to consider the acceleration of the target vehicle only in situations where it is necessary to consider the acceleration of the target vehicle.

Table 1 shows the relative acceleration of the target measured at the time point when the vehicle undergoes abrupt deceleration in the CCRs, CCRm, and CCRb scenarios, respectively.

TABLE 1

| Scenario | V_{SV}(km/h) | V_{TV}(km/h) | $\begin{matrix}{a}_{T V}^{′} ( km / {h}^{2} ) \\ ( {a}_{SV} \leq - 1 m / {s}^{2} )\end{matrix}$ |
|---|---|---|---|
| CCRs | 10 | 0 | 24 |
| | 20 | 0 | 10 |
| | 20 | 0 | 24 |
| | 30 | 0 | 24 |
| | 30 | 0 | 0 |
| | 40 | 0 | 0 |
| | 40 | 0 | 5 |
| | 50 | 0 | 25 |
| | 50 | 0 | 35 |
| | 60 | 0 | 30 |
| | 60 | 0 | 24 |
| CCRm | 30 | 20 | 24 |
| | 40 | 20 | 40 |
| | 40 | 24 | 14 |
| | 50 | 20 | 19 |
| | 50 | 20 | 9 |
| | 60 | 20 | 0 |
| | 60 | 20 | 20 |
| | 70 | 20 | 45 |
| | 70 | 20 | 40 |
| | 80 | 20 | 40 |
| | 80 | 20 | 50 |
| CCRb | 50 | 50 | −164 |
| | 50 | 50 | −210 |
| | 50 | 50 | −194 |
| | 50 | 50 | −214 |
| | 50 | 50 | −380 |
| | 50 | 50 | −105 |
| | 50 | 50 | −55 |
| | 50 | 50 | −644 |
| | 50 | 50 | −494 |

In Table 1, V_{SV} represents the velocity of a subject vehicle, V_{TV} represents the velocity of a target vehicle,

$${a}_{TV}^{′}$$

represents the relative acceleration of the target vehicle, and a_{SV} represents the absolute acceleration of the subject vehicle.

Referring to the CCRs scenario and CCRm scenario part of Table 1, the relative acceleration

$${a}_{T V}^{′}$$

of the target vehicle, measured at the time point when the acceleration of the subject vehicle a_{SV} becomes −1 m/s² or less, is a positive number regardless of the velocity of the subject vehicle V_{SV} and the velocity of the target vehicle V_{TV}. On the other hand, referring to the CCRb scenario part of Table 1, the relative acceleration

$${a}_{T V}^{′}$$

of the target vehicle, measured at the time point when the acceleration of the subject vehicle a_{SV} becomes −1 m/s² or less, is a negative number regardless of the velocity of the subject vehicle V_{SV} and the velocity of the target vehicle V_{TV}.

Therefore, the FCA device 100 may distinguish the CCRb scenario from the CCRs scenario and the CCRm scenario by using the sign of the relative acceleration

$${a}_{T V}^{′}$$

of the target vehicle measured at the time point when an error starts to develop in the sensor output due to abrupt deceleration of the subject vehicle. In one embodiment, the FCA device 100 determines that the current situation corresponds to the CCRb scenario if the relative acceleration

$${a}_{TV}^{′}$$

of the target vehicle, measured at the time point when the acceleration a_{SV} of the subject vehicle becomes −1 m/s² or less, is a negative number; the FCA device 100 determines that the current situation corresponds to the CCRs or CCRm scenario if the relative acceleration

$${a}_{TV}^{′}$$

of the target vehicle, measured at the time point when the acceleration a_{SV} of the subject vehicle becomes −1 m/s² or less, is a positive number.

Using the results obtained from FIGS. 3a to 3c and Table 1, the FCA device 100 may determine the acceleration a_{TV} of the target vehicle for generating a candidate position group of the target vehicle.

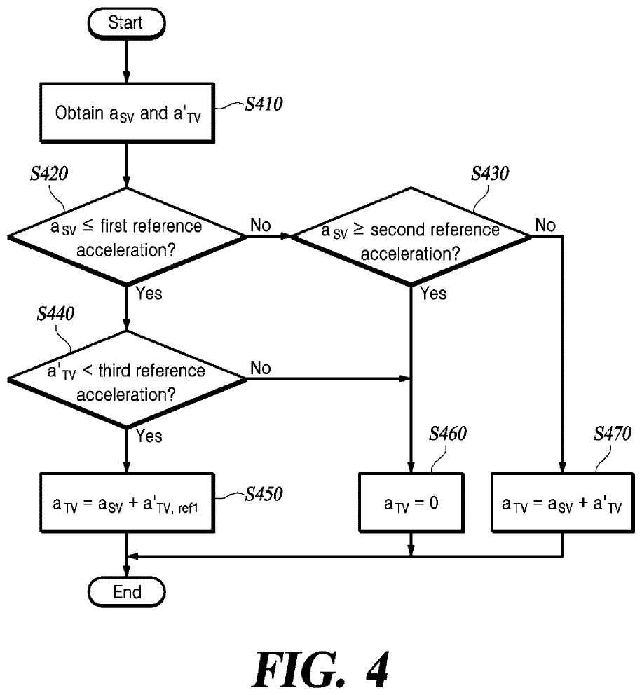

FIG. 4 is a flow diagram illustrating a process of determining the acceleration of the target vehicle to generate a candidate position group of the target vehicle by a FCA device according to one embodiment of the present disclosure.

The FCA device 100 obtains acceleration a_{SV} of the subject vehicle and relative acceleration

$${a}_{T V}^{′}$$

of the target vehicle using at least one sensor included in the subject vehicle S410.

The FCA device 100 determines whether the acceleration a_{SV} of the subject vehicle is less than or equal to a predetermined first reference acceleration S420. The first reference acceleration is set based on the acceleration of the subject vehicle at the time point when an error begins to occur in the sensor output due to deceleration of the subject vehicle. For example, referring to FIGS. 3a to 3c, the first reference acceleration may be set to −1 m/s².

If the acceleration a_{SV} of the subject vehicle exceeds the first reference acceleration, the FCA device 100 determines whether the acceleration a_{SV} of the subject vehicle is greater than or equal to a predetermined second reference acceleration S430. The second reference acceleration is set based on the acceleration of the subject vehicle at the time point when an error begins to occur in the sensor output due to the acceleration of the subject vehicle. For example, referring to FIGS. 3A to 3C, the second reference acceleration may be set to 1 m/s², which has the same magnitude as the first reference acceleration but has the opposite sign.

If the acceleration a_{SV} of the subject vehicle exceeds the first reference acceleration but is less than the second reference acceleration, error does not occur in the sensor output; therefore, the FCA device 100 determine the sum of the acceleration a_{SV} of the subject vehicle the relative acceleration

$${a}_{T V}^{′}$$

of the target vehicle as the acceleration a_{TV} of the target vehicle S470.

If the acceleration a_{SV} of the subject vehicle exceeds the second reference acceleration, an error occurs in the sensor output for obtaining the acceleration of the target vehicle; therefore, the sum of the acceleration a_{SV} of the subject vehicle and the relative acceleration

$${a}_{T V}^{′}$$

of the target vehicle may not be used as the acceleration a_{TV} of the target vehicle. Since this case does not correspond to the CCRb scenario, the FCA device 100 sets the acceleration a_{TV} of the target vehicle as 0 m/s² S460. In other words, the FCA device 100 does not consider the acceleration of the target vehicle when generating a candidate position group of the target vehicle.

If the acceleration a_{SV} of the subject vehicle is less than or equal to the first reference acceleration, the FCA device 100 determines whether the relative acceleration

$${a}_{T V}^{′}$$

of the target vehicle is less than or equal to a predetermined third reference acceleration S440. The third reference acceleration is set using the relative acceleration

$${a}_{T V}^{′}$$

of the target vehicle measured in the section where an error occurs in the sensor output due to the deceleration of the subject vehicle. The third reference acceleration is set to be smaller than the relative acceleration

$${a}_{T V}^{′}$$

of the target vehicle measured when the vehicle rapidly decelerates in the CCRs scenario and the CCRm scenario and set to be larger than the relative acceleration

$${a}_{T V}^{′}$$

of the target vehicle measured when the vehicle rapidly decelerates in the CCRb scenario. For example, referring to Table 1, the third reference acceleration may be set to 0 m/s².

If the relative acceleration

$${a}_{T V}^{′}$$

of the target vehicle is greater than or equal to the third reference acceleration, the situation corresponds to the CCRs or CCRm scenario; therefore, the FCA device 100 does not need to consider the acceleration a_{TV} of the target vehicle when generating a candidate position group of the target vehicle. Therefore, the FCA device 100 determines 0 m/s² as the acceleration a_{TV} of the target vehicle S460.

If the relative acceleration

$${a}_{T V}^{′}$$

of the target vehicle is less than the third reference acceleration, the situation corresponds to the CCRb scenario; therefore, the FCA device 100 sets the value obtained by adding the relative acceleration

$${a}_{T V , ref 1}^{′}$$

of the target vehicle at the time point when the acceleration a_{SV} of the subject vehicle becomes the first reference acceleration to the acceleration a_{SV} of the vehicle at the current time point as the acceleration of the target vehicle S450. When the acceleration of the subject vehicle a_{SV} is lower than or equal to the first reference acceleration, an error occurs in the relative acceleration

$${a}_{T V}^{′}$$

of the target vehicle measured using the sensor; therefore, the candidate position group of the target vehicle may not be generated using the relative acceleration

$${a}_{T V}^{′}$$

of the target vehicle measured in the section where the acceleration a_{SV} of the subject vehicle is lower than or equal to the first reference acceleration. Since the relative acceleration

$${a}_{TV}^{′}$$

of the target vehicle measured in the section where the acceleration a_{SV} of the subject vehicle is higher than or equal to the first reference acceleration may be trusted, the FCA device 100 uses the relative acceleration

$${a}_{TV , ref 1}^{′}$$

of the target vehicle acquired at the time point when the acceleration a_{SV} of the subject vehicle becomes the first reference acceleration as the relative acceleration

$${a}_{TV}^{′}$$

of the target vehicle in the section where the acceleration a_{SV} of the subject vehicle is lower than or equal to the first reference acceleration.

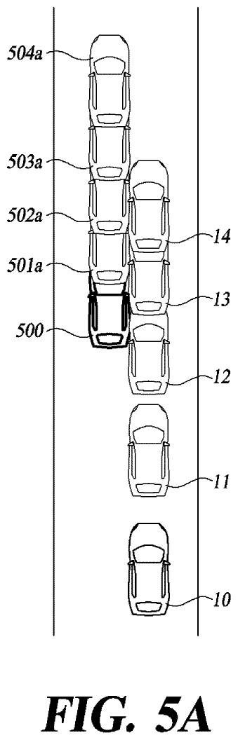

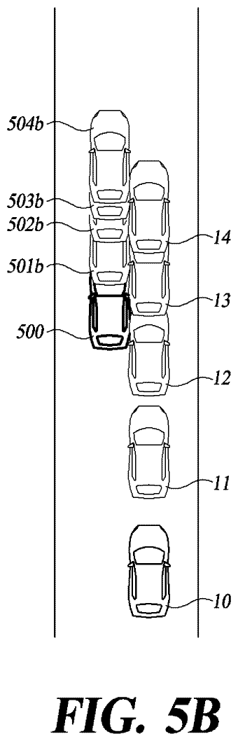

FIGS. 5A and 5B are drawings comparing the collision risk decision of a conventional FCA device with that of the FCA device 100 according to the present disclosure when a vehicle 10 applies emergency braking in the CCRb scenario.

FIG. 5A illustrates a method for a conventional FCA device to generate a candidate position group for a target vehicle and determine the collision risk when the subject vehicle 10 decelerates abruptly in the CCRb scenario. Since the conventional FCA device generates a candidate position group of the target vehicle without considering the acceleration of the target vehicle 500 when the subject vehicle 10 decelerates abruptly in the CCRb scenario, the target position candidates 501a to 504a are positioned at regular intervals. Since the subject vehicle 10 is decelerating, the vehicle position candidates 11 to 14 included in the candidate position group for the subject vehicle are positioned at increasingly narrower intervals as the candidate positions get farther from the current position of the subject vehicle 10. Since the position candidate of the target vehicle does not overlap with that of the subject vehicle at the same time point, the conventional FCA device may be unable to calculate the TTC and thus fail to determine the collision risk.

FIG. 5B illustrates a method for the FCA device 100 according to the present disclosure to generate a candidate position group for a target vehicle and determine the collision risk when the subject vehicle 10 decelerates abruptly in the CCRb scenario. Since the FCA device 100 generates a candidate position group of the target vehicle by considering the acceleration of the target vehicle 500 when the subject vehicle 10 decelerates abruptly in the CCRb scenario, the target position candidates 501b to 504b are positioned at increasingly narrower intervals as the candidate positions get farther from the current position of the target vehicle 500. Since the position candidate 504b of the target vehicle overlaps with the position candidate 14 of the subject vehicle at the same time point, the FCA device 100 determines the time point at which the subject vehicle position candidate 14 overlaps with the target vehicle position candidate 504b as the TTC. If the TTC is less than or equal to the last point to steer TTC (LPS TTC) or the last point to brake TTC (LPB TTC), the FCA device 100 determines that there is a high possibility of collision.

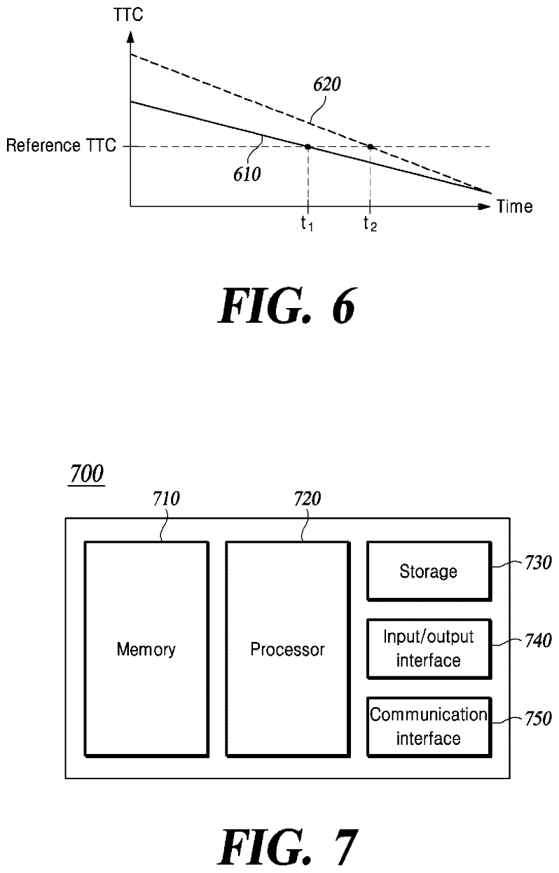

FIG. 6 is a graph illustrating the time point t₁ at which emergency braking is applied when the FCA device 100 according to the present disclosure is used and the time point t₂ at which emergency braking is applied when a conventional FCA device is used. The horizontal axis of the graph represents the driving time, and the vertical axis represents the TTC. The solid line 610 represents the TTC at each time point calculated using the FCA device 100 according to the present disclosure, and the dashed line 620 represents the TTC at each time point calculated using the conventional FCA device.

The FCA device 100 according to the present disclosure calculates the TTC 610 using the deceleration of the target vehicle; therefore, at time t₁, the TTC 610 calculated using the FCA device 100 according to the present disclosure is shorter than the TTC 620 calculated using the conventional forward collision avoidance device.

Therefore, the FCA device 100 according to the present disclosure may perform emergency braking earlier than the conventional FCA device. Referring to FIG. 6, when the conventional FCA device is used, since the TTC is less than or equal to the reference TTC (last point to steer TTC or last point to brake TTC) at time point t₂, the autonomous driving vehicle applies emergency braking from the time point t₂. On the other hand, when the FCA device 100 according to the present disclosure is used, since the TTC becomes less than or equal to the reference TTC from the time point t₁, the autonomous driving vehicle performs emergency braking from the time point t₁. The FCA device 100 according to the present disclosure may start emergency braking earlier than the conventional FCA device.

FIG. 7 is a block diagram of an exemplary computing device that may be used for implementing the method or the device according to the present disclosure.

The computing device 700 may include all or part of a memory 710, a processor 720, storage 730, an input/output interface 740, and a communication interface 750. The computing device 700 may structurally and/or functionally include at least a portion of the lateral offset calculation device. The computing device 700 may be a stationary computing device, such as a desktop computer or a server, as well as a mobile computing device, such as a laptop computer, a smartphone, or an automotive electronic device.

The memory 710 may store a program that enables the processor 720 to perform methods or operations according to various embodiments of the present disclosure. For example, a program may include a plurality of instructions executable by the processor 720, and the methods or operations described above may be performed by executing the plurality of instructions by the processor 720. The memory 710 may consist of a single memory or a plurality of memories. In this case, information required to perform the methods or operation according to various embodiments of the present disclosure may be stored in a single memory or distributed across a plurality of memories. When the memory 710 is composed of a plurality of memories, the plurality of memories may be physically separated. The memory 710 may include at least one of volatile memory and non-volatile memory. Volatile memory includes Static Random Access Memory (SRAM) or Dynamic Random Access Memory (DRAM), while non-volatile memory includes flash memory.

The processor 720 may include at least one core capable of executing at least one instruction. The processor 720 may execute instructions stored in the memory 710. The processor 720 may consist of a single processor or a plurality of processors.

The storage 730 maintains stored data even if power supplied to the computing device 700 is cut off. For example, the storage 730 may include non-volatile memory or may include a storage medium such as a magnetic tape, an optical disk, or a magnetic disk. A program stored in the storage 730 may be loaded into the memory 710 before being executed by the processor 720. The storage 730 may store files written in a program language, and a program created from the files by a compiler may be loaded into the memory 710. The storage 730 may store data to be processed by the processor 720 and/or data processed by the processor 720.

The input/output interface 740 may provide an interface with an input device such as a keyboard or a mouse and/or an output device such as a display device or a printer. The user may trigger execution of a program by the processor 720 through the input device and/or check the processing results of the processor 720 through the output device.

The communication interface 750 may provide access to an external network. The computing device 700 may communicate with other devices through the communication interface 750.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for preventing a collision between a vehicle and a target in front of the vehicle, the method comprising:
obtaining, by at least one processor, vehicle acceleration and relative target acceleration, using at least one sensor of the vehicle, wherein the vehicle acceleration is an absolute acceleration of the vehicle and the relative target acceleration is a relative acceleration of the target relative to the vehicle;
determining, by the at least one processor, a target acceleration based on the vehicle acceleration and the relative target acceleration, wherein the target acceleration is an absolute acceleration of the target; and
determining, by the at least one processor, a time-to-collision (TTC) based on the target acceleration.

2. The method of claim 1, wherein:
if the vehicle acceleration is larger than a predetermined, first reference acceleration, the relative target acceleration is relative acceleration of the target at a current time point, and
if the vehicle acceleration is less than or equal to the first reference acceleration, relative acceleration of the target at a time point of an abrupt deceleration of the vehicle.

3. The method of claim 2, wherein, at the time point of the abrupt deceleration, an error starts to occur in output of the at least one sensor due to the abrupt deceleration of the vehicle.

4. The method of claim 2, wherein the first reference acceleration is determined based on acceleration of the vehicle at the time point of the abrupt deceleration.

5. The method of claim 2, wherein, if the vehicle acceleration is larger than the first reference acceleration:
if the vehicle acceleration is larger than or equal to a predetermined, second reference acceleration, the target acceleration is determined to be 0 m/s², and
if the vehicle acceleration is less than the second reference acceleration, the target acceleration is determined based on the vehicle acceleration and the relative acceleration of the target at the current time point.

6. The method of claim 5, wherein the second reference acceleration is determined based on acceleration of the vehicle at a time point of an abrupt acceleration of the vehicle.

7. The method of claim 6, wherein, at the time point of the abrupt acceleration, an error starts to occur in output of the at least one sensor due to the abrupt acceleration of the vehicle.

8. The method of claim 2, wherein, if the vehicle acceleration is less than or equal to the first reference acceleration:
if the relative target acceleration is less than a predetermined, third reference acceleration, the target acceleration is determined based on the vehicle acceleration and the relative acceleration of the target at the time point of the abrupt deceleration of the vehicle,
if the relative target acceleration is larger than or equal to the third reference acceleration, the target acceleration is determined to be 0 m/s².

9. The method of claim 8, wherein the third reference acceleration is less than the relative acceleration of the target at a time point of the abrupt deceleration of the vehicle measured in CCRs and CCRm scenarios, and larger than relative acceleration of the target at a time point of the abrupt deceleration of the vehicle measured in CCRb scenario.

10. An apparatus for preventing a collision between a vehicle and a target in front of the vehicle, the apparatus comprising:
at least one memory for storing commands; and
at least one processor,
wherein the at least one processor executes the commands to:
obtain vehicle acceleration and relative target acceleration, using at least one sensor of the vehicle, wherein the vehicle acceleration is an absolute acceleration of the vehicle and the relative target acceleration is a relative acceleration of the target relative to the vehicle;
determine a target acceleration based on the vehicle acceleration and the relative target acceleration, wherein the target acceleration is an absolute acceleration of the target; and
determine time-to-collision (TTC) based on the target acceleration.

11. The apparatus of claim 10, wherein:
if the vehicle acceleration is larger than a predetermined, first reference acceleration, the relative target acceleration is a relative acceleration of the target at a current time point, and
if the vehicle acceleration is less than or equal to the first reference acceleration, the relative target acceleration is a relative acceleration of the target at a time point of an abrupt deceleration of the vehicle.

12. The apparatus of claim 11, wherein, at the time point of the abrupt deceleration, an error starts to occur in output of the at least one sensor due to the abrupt deceleration of the vehicle.

13. The apparatus of claim 11, wherein the first reference acceleration is determined based on the acceleration of the vehicle at the time point of the abrupt deceleration.

14. The apparatus of claim 11, wherein, if the vehicle acceleration is larger than the first reference acceleration:
if the vehicle acceleration is larger than or equal to a predetermined, second reference acceleration, the target acceleration is determined to be 0 m/s², and
if the vehicle acceleration is less than the second reference acceleration, the target acceleration is determined based on the vehicle acceleration and the relative acceleration of the target at the current time point.

15. The apparatus of claim 14, wherein the second reference acceleration is determined based on acceleration of the vehicle at a time point of an abrupt acceleration of the vehicle.

16. The apparatus of claim 15, wherein, at the time point of the abrupt acceleration, an error starts to occur in output of the at least one sensor due to the abrupt acceleration of the vehicle.

17. The apparatus of claim 10, wherein, if the vehicle acceleration is less than or equal to the first reference acceleration:
if the relative target acceleration is less than a predetermined, third reference acceleration, the target acceleration is determined based on the vehicle acceleration and the relative acceleration of the target at the time point of the abrupt deceleration of the vehicle,
if the relative target acceleration is larger than or equal to the third reference acceleration, the target acceleration is determined to be 0 m/s².

18. The apparatus of claim 17, wherein the third reference acceleration is less than relative acceleration of target at a time point of the abrupt deceleration of the vehicle measured in CCRs and CCRm scenarios, and larger than relative acceleration of the target at a time point of the abrupt deceleration of the vehicle measured in the CCRb scenario.

19. A vehicle comprising the apparatus of claim 10.

20. A non-transitory computer readable medium containing program instructions executed by a processor, the computer readable medium comprising:
program instructions that obtain vehicle acceleration and relative target acceleration, using at least one sensor of a vehicle, wherein the vehicle acceleration is an absolute acceleration of the vehicle and the relative target acceleration is a relative acceleration of the target relative to the vehicle;
program instructions that determine a target acceleration based on the vehicle acceleration and the relative target acceleration, wherein the target acceleration is an absolute acceleration of the target; and
program instructions that determine a time-to-collision (TTC) based on the target acceleration.
